(19) United States
(12) Patent Application Publication
(10) Pub. No.: US 2011/0096417 A1
(43) Pub. Date: Apr. 28, 2011

(54) LENS ARRANGEMENT AND RELATED LENS MODULE

(75) Inventors: SHIH-CHIEH YEN, Tu-Cheng (TW); CHAI-WEI LEE, Tu-Cheng (TW)

(73) Assignee: HON HAI PRECISION INDUSTRY CO., LTD., Tu-Cheng (TW)

(21) Appl. No.: 12/749,480

(22) Filed: Mar. 29, 2010

(30) Foreign Application Priority Data
Oct. 26, 2009 (CN) 200910308806.6

(51) Int. Cl. G02B 7/02

(52) U.S. Cl. 359/819; 359/811

(57) ABSTRACT

A lens arrangement includes two lenses. Each lens includes an imaging portion having an optical axis, a non-imaging portion surrounding the imaging portion, and an annular engagement portion extending outwards from the non-imaging portion along the optical axis. The engagement portions are interferentially engaged with each other. The diameter difference of the engagement portion is greatly smaller than the dimension of the lens to ensure that the engagement portions efficiently and sufficiently deforms while the deformation of the engagement portion is not transmitted to the imaging portion.

### BACKGROUND

1. Technical Field

This present disclosure relates to lenses and, particularly, to a lens arrangement and a related lens module.

2. Description of Related Art

Lens modules typically include a lens barrel and a number of lenses received within the lens barrel. At present, the lenses can be separately held by the lens barrel directly, or engaged with each other to form a lens arrangement and then held by the lens barrel.

If the lens barrel separately holds the lenses directly, it is first required to precisely form the lens barrel and the lenses so that all lenses can fit into the lenses barrel. Furthermore, an alignment of the lenses is always less than satisfactory and also greatly affected by the precision of the lens barrel since the lens barrel separately holds the lenses. Thus, it is difficult to achieve a high imaging quality of the lens module.

If the lenses are engaged with each other firstly, the alignment of the lenses can be satisfactorily achieved by coaxially engaging the lenses. However, if the precision of any lens is less than satisfactory, the coaxial engagement of the lenses may be lost if the lenses become too loose, or the lenses may be deformed if the lenses become too tight. These two occurrences will reduce the imaging quality of the lens module.

Therefore, it is desirable to provide a lens arrangement and a lens module, which can overcome the above-mentioned limitations.

### BRIEF DESCRIPTION OF THE DRAWINGS

FIG. 1 is a cross-sectional, exploded view of a lens arrangement, according to an exemplary embodiment.

FIG. 2 is a cross-sectional, assembled view of the lens arrangement of FIG. 1.

FIG. 3 is a cross-sectional view taken along a line III-III of FIG. 1.

FIG. 4 is a cross-sectional view taken along the line IV-IV of FIG. 1.

FIG. 5 is a cross-sectional view of a lens module, according to an exemplary embodiment.

### DETAILED DESCRIPTION

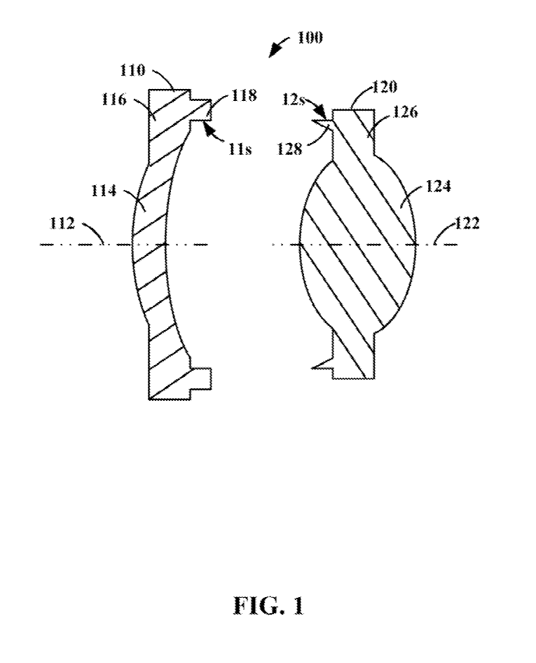

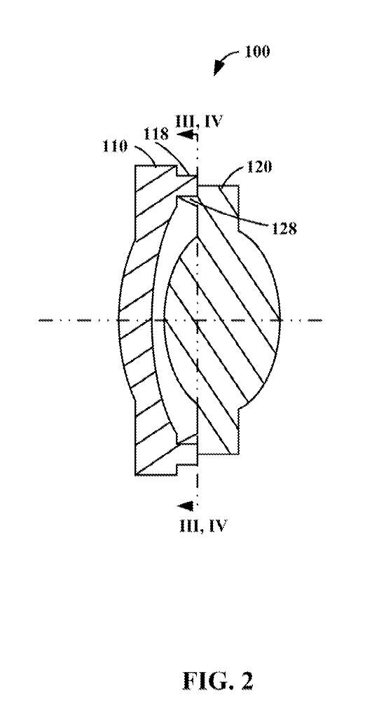

Referring to FIGS. 1-2, a lens arrangement 100, according to an exemplary embodiment, includes first lens 110 and second lens 120.

The first lens 110 and second lens 120 can be plastic or glass lenses. In this embodiment, the first lens 110 and second lens 120 are plastic lenses.

The first lens 110 includes a first imaging portion 114 and a first non-imaging portion 116. The first imaging portion 114 is for refracting incident light rays and forming corresponding optical images, and defines a first optical axis 112. The first non-imaging portion 116 surrounds the first imaging portion 114 and is configured for engaging with the second lens 120. The first lens 110 further includes a first engagement portion 118 protruding outwards from the first non-imaging portion 116 along and symmetrical about the first optical axis 112. The first engagement portion 118 is substantially annular and symmetrical about the first optical axis 112. The radial thickness of the engagement portion 118 is greatly smaller than, for example, less than 10% of, the diameter and/or the thickness of the first lens 110. The first engagement portion 118 includes an inner circumferential engagement surface 11s.

The second lens 120 includes a second imaging portion 124 and a second non-imaging portion 126. The second imaging portion 124 is also for refracting incident light rays and forming corresponding optical images, and defines a second optical axis 122. The second non-imaging portion 126 surrounds the second imaging portion 124 and configured for engaging with the first lens 110. The second lens 120 also includes a second engagement portion 128 protruding outwards from the second non-imaging portion 126 along and symmetrical about the second optical axis 122. The second engagement portion 128 is substantially annular and symmetrical about the second optical axis 122 too. The radial thickness of the second engagement portion 128 is greatly smaller than, for example, less than 10% of, the diameter of the second lens 120. The second engagement portion 128 includes an outer circumferential engagement surface 12s.

The diameter of the inner circumferential engagement surface 11s is substantially equal to or slightly less than that of the outer circumferential engagement surface 12s. Therefore, the first lens 110 and the second lens 120 can be tightly engaged with each other via friction between the inner circumferential engagement surface 11s and the outer circumferential engagement surface 12s.

Upon assembly, the first optical axis 112 coincides with the second optical axis 122, constituting a common optical axis of the lens arrangement 100. As such, an alignment of the first lens 110 and the second lens 120 is achieved.

Since the thickness of the first engagement portion 118 and the second engagement portion 128 are relatively small compared to the first lens 110 and the second lens 120. The first engagement portion 118 and the second engagement portion 128 can be efficiently and sufficiently deformed due to an imprecise alignment of the first engagement portion 118 and the second engagement portion 128, without effecting the first imaging portion 114 and the second imaging portion 124. Thus, the imaging quality of the lens arrangement 100 is protected from the deformations due to an imprecise alignment of portions 118 and 128.

It is noteworthy that the cross sections of the first engagement portion 118 along the first optical axis 112 and the second engagement portion 128 along the second optical axis 122 can be rectangular, triangular, or right-angled trapezoid.

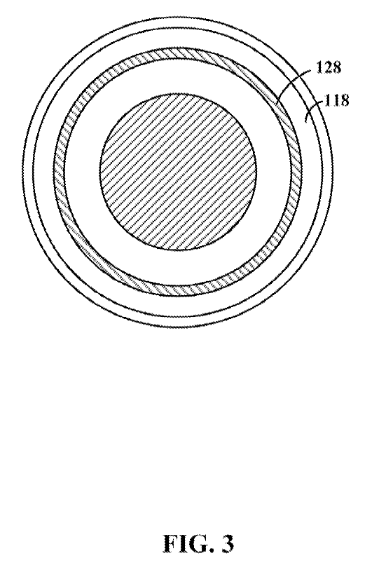

Referring to FIG. 3, both the first engagement portion 118 and the second engagement portion 128 continuously extend along a circumferential direction thereof.

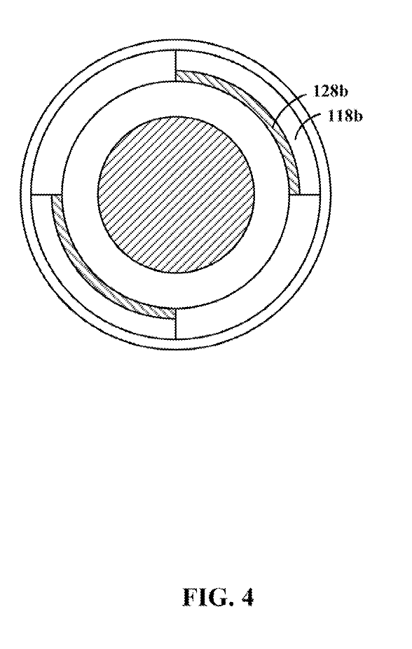

Referring to FIG. 4, alternatively, both the first engagement portion 118 and the second engagement portion 128 extend along a portion of the circumference. That is, the first engagement portion 118 comprises two first arc blocks 118b, and the second engagement portion 128 comprises two second arc blocks 128b. However, it should be understood that the numbers of the first arc blocks 118b and the second arc blocks 128b are not limited to two, but can be more or less than two depending on requirements. In this embodiment, the first arc blocks 118b and the second arc blocks 128b are formed and equal distance apart. However, the distributions the first arc blocks 118b and the second arc blocks 128b are not limited to this embodiment, and can be distributed at an unequal distance, provided that the first arc blocks 118b and the second arc block 118 are correspondingly positioned. Also, in other alternative embodiment, the first engagement portion 118 can continuously (or discontinuously) extend while the second engagement portion 128 is not.

It should be noteworthy that the lens arrangement 100 can include more than two lenses. Each two adjacent lenses are engaged in such a way similar to that of the first lens 110 and the second lens 120.

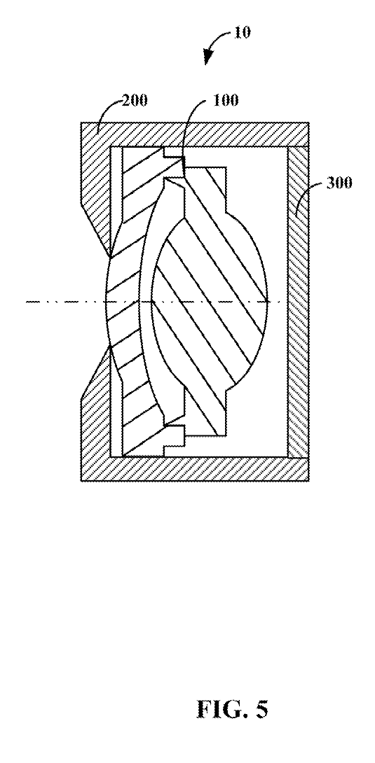

Referring to FIG. 5, a lens module 10, according to an exemplary embodiment, includes the lens arrangement 100, a lens barrel 200, and a color filter 300. The lens barrel 200 holds the lens arrangement 100 and the color filter 300.

While various exemplary and preferred embodiments have been described, it is to be understood that the disclosure is not limited thereto. Various modifications and similar arrangements can also be covered as would be apparent to those skilled in the art.

Therefore, the scope of the appended claims should be accorded the broadest interpretation so as to encompass all such modifications and similar arrangements.

What is claimed is:

1. A lens arrangement comprising:
two lenses, each of which comprises an imaging portion having an optical axis, a non-imaging portion surrounding the imaging portion, and an annular engagement portion extending outwards from the non-imaging portion along the optical axis; the engagement portions being interferentially engaged with each other, the diameter difference of the engagement portion being greatly smaller than the dimension of the lens to ensure that the engagement portions efficiently and sufficiently deforms while the deformation of the engagement portion is not transmitted to the imaging portion.

2. The lens arrangement of claim 1, wherein the lenses are selected from the group consisting of a plastic lens and a glass lens.

3. The lens arrangement of claim 1, wherein the engagement portion is symmetrical about the optical portion.

4. Then lens arrangement of claim 1, wherein the geometrical shape of the cross section of the engagement portion along the optical axis is selected from the group consisting of a rectangle, a triangle, and a right-angled trapezoid.

5. The lens arrangement of claim 1, wherein the engagement portion continuously extends along a circumferential direction of the respective non-imaging portion.

6. The lens arrangement of claim 1, wherein the engagement portion discontinuously extends along a circumferential direction of the respective non-imaging portion.

7. The lens arrangement of claim 6, wherein the engagement portion comprising a plurality of arc blocks distributed around the circumferential direction of the respective non-imaging portion.

8. The lens arrangement of claim 7, wherein the arc blocks are equidistantly distributed.

9. The lens arrangement of claim 1, wherein the diameter difference of the engagement portion is less than 10% of the dimension of the lens.

10. A lens module comprising:
a lens barrel; and
a lens arrangement held by the lens barrel, the lens arrangement comprising:
two lenses, each of which comprises an imaging portion having an optical axis, a non-imaging portion surrounding the imaging portion, and an annular engagement portion extending outwards from the non-imaging portion along the optical axis; the engagement portions being interferentially engaged with each other, the diameter difference of the engagement portion being greatly smaller than the dimension of the lens to ensure that the engagement portions efficiently and sufficiently deforms while the deformation of the engagement portion is not transmitted to the imaging portion.

11. The lens module of claim 10, further comprising a color filter held by the lens barrel.

12. The lens module of claim 10, wherein the lenses are selected from the group consisting of a plastic lens and a glass lens.

13. The lens module of claim 10, wherein the engagement portion is symmetrical about the optical portion.

14. Then lens module of claim 10, wherein the geometrical shape of the cross section of the engagement portion along the optical axis is selected from the group consisting of a rectangle, a triangle, and a right-angled trapezoid.

15. The lens module of claim 10, wherein the engagement portion continuously extends along a circumferential direction of the respective non-imaging portion.

16. The lens module of claim 10, wherein the engagement portion discontinuously extends along a circumferential direction of the respective non-imaging portion.

17. The lens module of claim 16, wherein the engagement portion comprising a plurality of arc blocks distributed around the circumferential direction of the respective non-imaging portion.

18. The lens module of claim 17, wherein the arc blocks are equal-distantly distributed.

19. The lens module of claim 10, wherein the diameter difference of the engagement portion is less than 10% of the dimension of the lens.
